(19) United States
(12) Patent Application Publication
(10) Pub. No.: US 2009/0132421 A1
(43) Pub. Date: May 21, 2009

(54) Secured Disc

(76) Inventor: Richard H. Selinfreund, Clinton, CT (US)

Correspondence Address: KELLEY DRYE & WARREN LLP, 400 ALTLANTIC STREET , 13TH FLOOR, STAMFORD, CT, 06901, US

(21) Appl. No.: 11/943,861

(22) Filed: Nov. 21, 2007

Related U.S. Application Data
(60) Provisional application No. 60/869,571.

(51) Int. Cl. H04L 9/00

(52) U.S. Cl. 705/51

(57) ABSTRACT

A secured disc.

### CROSS-REFERENCE TO RELATED APPLICATIONS

This application claims priority to U.S. Provisional Application No. 60/869,571, filed Dec. 12, 2006, the disclosure of which is incorporated by reference herein in its entirety to the extent not contrary to the present disclosure.

### BACKGROUND OF THE INVENTION

A secured disc that allows access to a website through a particular portal to allow actions in the website not permitted without the use of the secured disc. Such actions may include the depositing of funds into a 529 fund, such as a college or retirement fund.

### DESCRIPTION OF THE RELATED ART

Current technology provides for use of a disc that is secured by a personal identity code or password. Techniques are known for checking a disc for authenticity and allowing play upon discernment of authenticity. The .exe run may allow access to content on an exclusive website, such as, for example, through a Secure Web Link.

### DETAILED DESCRIPTION OF THE INVENTION

In embodiments, there is a secured disc that is pre-coded with a unique identifier and which allows access to an executable only upon discernment of the unique identifier. The secured disc is also operatively configured to lock to the portal on which it is read. The executable may allow access to a secure web site. By wrapping the executable with the unique identifier, the disc is protected against copying, that is copied discs will not be authenticated and the executable will not run. By configuring the disc to lock to a particular portal on which it is first read, there is provided security that the person using the disc as a key is indeed the person who is authorized to use the disc.

By disc it is meant to include herein, any digital medium of any shape.

In one embodiment, a PID is incorporated onto the disc along with a security program which allows an executable to be run only upon recognition of the existence of the PID. The disc may be further operatively configured to lock the disc to the player, computer, or other device upon which it is first read. The executable may by configured to allow access to a web site if the PID is recognized. Further, any action on the website may require recognition that the disc is being read on the player, computer, or other device upon which it was first read.

In an embodiment, the security disc allows access to a web site that permits transfer of funds recorded on the disc to a 529 sanctioned program, for example, a college savings program or a retirement fund. The funds may be provided as way of an enticement to buyers to purchase a product, knowing that a portion of the proceeds that they pay for the disc may go towards a 529 program. The PID on the disc allows the disc to be tracked and moved into the right log-in space on the website, allowing for example, access to personal information without having to input a secret code. In effect, the disc acts as the password.

In one embodiment, a media piece comes with a secure and unique card that cannot be copies. In alternative, the media piece comes with a secure and unique card that cannot be copied. In alternative, the media piece itself may be secure and unique and protected against copying. Upon loading of the media piece or the secure and unique card, funds may be transferred from the media to a 529 program, such as a college or retirement fund. The fund may be hosted by a number of parties. The particular fund into which the transfer is made may be provided as a series of options, or manual input of the same may be required. The transfer of capital to such funds may be used as an enticement to purchasers to purchase a particular product over a competitor's product.

In yet another embodiment, there is provided a unique card having inscribed thereon a PID and a Secure Rom program, such as Sony Secure Rom. The unique card may further be wrapped with a media locking algorithm that makes each disc the individual and unique password. PID makes each card unique. The Secure Rom program makes it difficult for someone to make a copy of a disc to get unauthorized credit. The media locking software launches the computer identity separately into the database allowing verification that the person making the transaction belongs to the computer.

In yet another embodiment, there is provided a Playstation disc set that comes with an additional disc. The additional disc acts as a key to allow funds to be credited toward an authorized 529 program, such as a college savings program or a retirement fund. The Playstation disc thus comes with a secure and unique card that cannot be copied. The disc, however, when placed into a particular player will allow logging into a particular server and allow funds to be deposited into a 529 program. In one aspect, the person logging into the secure web site receives a 529 form, or questions allowing a 529 form to be filed. The fund may be owned by a third party who may receive a small transaction fee associated with each deposit and roll over. The fund's beneficiary may be a third party, for example, a child.

The disc may be data configured to require the disc to be checked for authenticity and upon ascertainment of authenticity, allowing an .exe to run As a copy would not be authenticate, the .exe would not run on a copy. The .exe function allows for access to check to determine if the disc is being run on the machine, reader, player, etc. upon which it was first loaded. By tying the disc to such machine, the probability that the particular household is using a valid disc is enhanced. A PID may be used to allow the disc to be tracked and moved into the right log-in space on the website, that allowing, for example, access to personal financial information without having to know and code-in a secret code.

The disc in some embodiments may be accessed from the home computer or can be taken to any local store that offers store-Web-Secure-ID. As no password is required, the media itself is a password. Upon authentication of the disc, financial information pertaining to the selected account can be accessed.

What is claimed is:

1. A secured disc comprising a PID, an executable which is executed only upon discerning the PID on the secured disc, and a program for locking the secured disc to the device upon which it is first read.

2. A method for depositing funds into a 529 program comprising:
determining that a disc having a monetary amount stored thereon is authenticate;
permitting access to a secured website upon determination that the disc is authenticate; and
allowing through said secured website the monetary amount on said disc to be transferred to a 529 program hosted by said website.
